(19) United States
(12) Patent Application Publication
(10) Pub. No.: US 2012/0205960 A1
(43) Pub. Date: Aug. 16, 2012

(54) Passenger Restraint Attachment

(76) Inventor: Christopher L. Finch, Bradenton, FL (US)

(21) Appl. No.: 13/029,099

(22) Filed: Feb. 16, 2011

(51) Int. Cl. A62B 35/04; B60R 22/00; B60R 21/00

(52) U.S. Cl. 297/470; 297/464

(57) ABSTRACT

A passenger restraint attachment for use by a passenger when wearing a passenger restraint having a shoulder harness for securing an upper torso of the passenger. The passenger restraint attachment includes a cushion having an upper portion including a shoulder harness receiver. A lower portion of the cushion has an S-shaped lower surface for engaging the body of the passenger.

### FIELD OF THE INVENTION

The present invention generally relates to passenger restraint devices, and more specifically to an attachment that reduces passenger discomfort and wrinkling of passenger clothing caused by passenger restraints.

### BACKGROUND OF THE INVENTION

It is well established that a higher incidence of fatalities and serious injuries occurs in passengers who are not wearing a passenger restraint during an automobile accident as compared to passengers who are wearing a passenger restraint. Additionally, passengers who are not correctly wearing a passenger restraint during an accident are more likely to be injured or killed. In spite of these statistics, passengers often fail to wear a passenger restraint or fail to wear a passenger restraint properly.

Conventional automotive passenger restraints include a lap belt positioned across the hips of the passenger and a shoulder strap extending diagonally across the passenger's torso from a position adjacent the passenger's hip to a position on the automobile frame adjacent the passenger's shoulder. Failure to wear passenger restraints or wear them properly is frequently attributed to discomfort caused by pressure applied by passenger restraints and/or disheveled clothing caused by passenger restraint contact. More particularly, passenger restraint shoulder straps, or more broadly shoulder harnesses, are often singled out as causing discomfort and wrinkled clothes. Furthermore, passengers with a medical impairment on their upper torso, such as a dislocated shoulder or sensitivity due to a recent surgery or procedure on the upper torso, experience even greater levels of discomfort from the shoulder harness. As a result of these nuisances, many passengers fail to wear their passenger restraint or wear it in such a way that the shoulder harness is ineffective.

Conventional devices addressing the issue of discomfort caused by shoulder harnesses provide a cushion covering the harness. The cushions reduce some discomfort, but do little to reduce clothes wrinkling. Thus, the conventional devices do not eliminate all of the objections passengers have to wearing restraints or wearing them properly. Accordingly, there is a need for a device that further reduces passenger discomfort and clothes wrinkling caused by shoulder harnesses.

### SUMMARY OF THE INVENTION

In one aspect of the present invention, a passenger restraint attachment for use by a passenger when wearing a passenger restraint having a shoulder harness for securing an upper torso of the passenger generally comprises a cushion. The cushion has an upper portion including a shoulder harness receiver. A lower portion of the cushion has an S-shaped lower surface for engaging the body of the passenger.

In another aspect, the present invention includes a passenger restraint attachment for use by a passenger when wearing a passenger restraint having a shoulder harness for securing an upper torso of the passenger. The passenger restraint attachment comprises a closed cell foam portion for absorbing shock applied to the passenger by the shoulder harness due to changes in vehicle velocity. The closed cell foam portion includes a slot adapted to receive the shoulder harness. An open cell foam portion is mounted on the closed cell foam portion. The open cell foam portion conforms to a shape of a corresponding part of the passenger. The open cell foam portion is adapted to extend from a location on the upper torso behind a shoulder of the passenger to a location of the upper torso in front of the shoulder.

In yet another aspect, the present invention includes a passenger restraint attachment for use by a passenger when wearing a passenger restraint having a shoulder harness for securing an upper torso of the passenger. The passenger restraint attachment comprises a cushion having an upper portion including a shoulder harness receiver and a lower portion having a lower surface including a concave area for engaging a shoulder of the passenger. In use, the shoulder harness receiver engages the shoulder harness and cantilevers the harness away from a forward edge of the concave area by a distance that is greater than about 1.25 inches.

Other objects and features will be in part apparent and in part pointed out hereinafter.

### BRIEF DESCRIPTION OF THE DRAWINGS

FIG. 1 is a perspective of a first embodiment of a passenger restraint attachment according to the present invention in use by a passenger wearing a passenger restraint;

FIG. 2 is a perspective of the first embodiment illustrating one configuration for receiving a shoulder harness;

FIG. 3 is a perspective of the first embodiment illustrating a second configuration for receiving a shoulder harness;

FIG. 4 is a perspective of a second embodiment of a passenger restraint attachment according to the present invention; and

FIG. 5 is a separated view of the second embodiment.

Corresponding reference characters indicate corresponding parts throughout the drawings.

### DESCRIPTION OF THE PREFERRED EMBODIMENTS

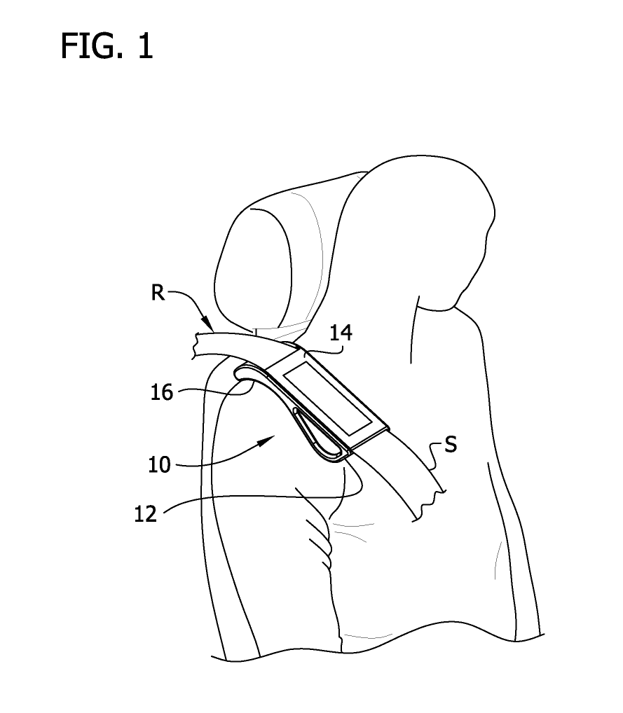

Referring the drawings and in particular, FIG. 1, a passenger restraint attachment of the present invention is designated in its entirety by the reference number 10. The attachment 10 is intended for use by a passenger when wearing a passenger restraint, generally designated by R, having a shoulder harness S for securing an upper torso of the passenger. As shown in FIG. 1, the passenger restraint attachment 10 generally comprises a cushion 12, including an upper portion 14 and a lower portion 16.

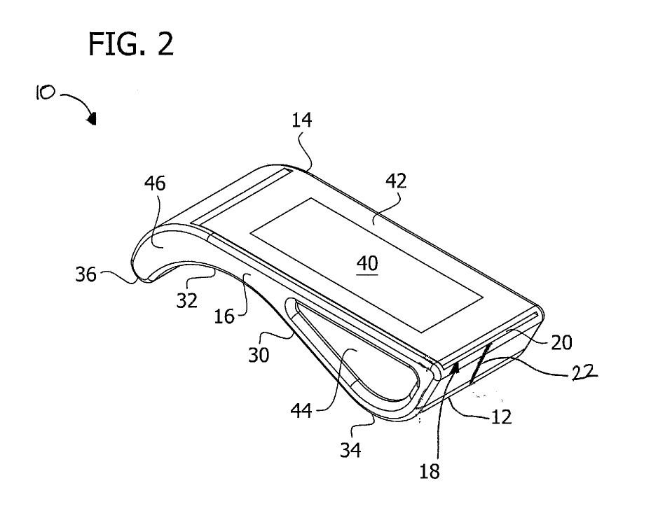

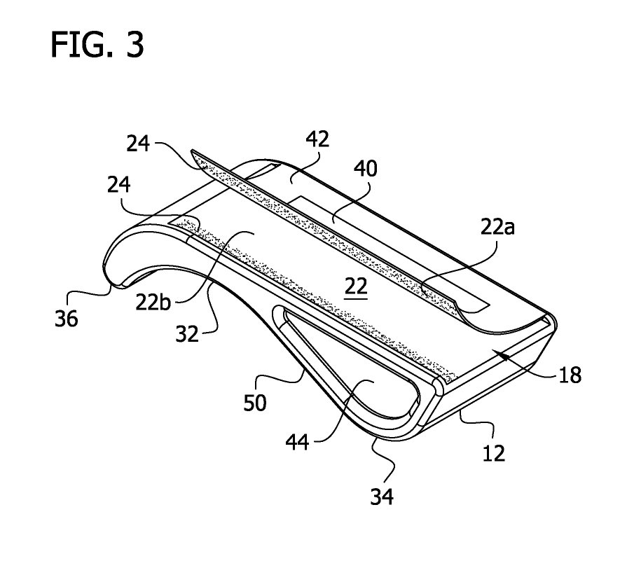

The upper portion 14 of the attachment 10 includes a shoulder harness receiver, generally designated by 18. As its name implies, the receiver 18 receives the shoulder harness S of the passenger restraint R. Although it is envisioned that the shoulder harness receiver 18 may take other forms without departing from the scope of the present invention, in one embodiment the receiver is formed as a slot 20 in the upper portion 14 sized for receiving a conventional automotive shoulder harness S. In one configuration of the first embodiment, as shown in FIG. 2, an opening 22 is provided at the bottom of the slot 20 to allow the shoulder harness S to be inserted into the slot. Opposing surfaces of the opening 22 may include fasteners for selectively closing the opening. For example, in some embodiments the fasteners are conventional fabric hook and loop fasteners. In other embodiments, the fasteners are plug and socket type fasteners. In another configuration of the first embodiment, as shown in FIG. 3, the slot 20 is open along one side for wrapping the upper portion 14 around the shoulder harness S. In some embodiments, opposing surfaces 22a, 22b of the opening 22 of the slot 20 have fasteners 24 for selectively closing the opening. For example, in one embodiment the fasteners 24 are conventional fabric hook and loop fasteners. As will be apparent to those skilled in the art, the opening 22 configurations shown in FIGS. 2 and 3 of the illustrated embodiment of the shoulder harness receiver 18 permit the shoulder harness S to slide freely within the upper portion 14, so that the passenger restraint can move in response to movement of the passenger. In some embodiments, at least one surface of the slot is covered with a low friction material, such as plastic, to facilitate free sliding of the passenger restraint within the upper portion. The material is located between the upper portion and the passenger restraint, such that it provides the added benefit of protecting the upper portion from wear due to contact with the passenger restraint.

Although the upper portion 14 may be made of other materials and using other processes, in one embodiment the upper portion is molded from a closed cell foam, such as a medium density closed cell foam. More particularly, in some embodiments the upper portion 14 is molded from a closed cell foam made of recycled materials.

The lower portion 16 of the cushion 12 is configured to be positioned against the body of the passenger. More specifically, the lower portion 16 includes a generally S-shaped lower surface 30 that generally corresponds to the shoulder of a passenger. The S-shaped surface 30 includes a concave rearward portion 32 and a convex forward portion 34. A lip or retainer 36 formed at a rearward end of the concave portion 32 hooks over a top of the passengers shoulder to retain the cushion 12 in position. Even though shoulder harness S can freely slide within the shoulder harness receiver 18 as the passenger and harness move with respect to each other, the passenger restraint attachment 10 does not move out of place on the passenger's shoulder because of retainer 36. The concave portion 32 of the lower surface 30 is configured to engage and cradle the shoulder of the passenger. The convex portion 34 of the lower surface 30 rests against the passenger immediately below the concave portion 32 of the lower surface.

As will be apparent to those skilled in the art, the convex portion 34 cantilevers the shoulder harness S away from the passenger's body and clothes. When the harness S does not press against the clothes, it cannot cause wrinkling. Thus, by lifting the harness S away from the passenger's clothes, the attachment 10 reduces the potential for clothes wrinkling and eliminates one objection passengers may have to wearing restraints R. Furthermore, by lifting the harness S away from the passenger's upper torso, the attachment 10 reduces pressure on some portions of the upper torso that the shoulder harness, thereby eliminating another objection passengers may have to wearing restraints R. Although the passenger restraint attachment 10 may lift the harness S away from a forward edge 50 of the concave portion 32 by other distances without departing from the scope of the present invention, in one embodiment the attachment cantilevers the harness away from the forward edge 50 by a distance that is greater than about 1.25 inches. In other embodiments, this distance is in a range from about 1.25 inches to about 2.0 inches. In still other embodiments, the distance is in a range from about 1.5 inches to about 1.75 inches.

Although the lower portion 16 may be made of other materials and using other processes, in one embodiment the lower portion is molded from an open cell foam, and more particularly from a viscoelastic “memory” foam. The nature of such memory foam is to be highly conformable under load. This property causes the attachment 10 to distribute loads from shoulder harness S and readily conform to the passenger's shoulder. As a result, the attachment 10 is extraordinarily comfortable compared to conventional passenger restraint attachments, which do not have the shape or materials found in the attachment of the present invention. The open cell foam also absorbs shock applied to the passenger by the shoulder harness S due to changes in vehicle velocity, such as sudden vehicle deceleration. Because the open cell foam absorbs the loads that would otherwise be transmitted to the passenger, potential common passenger-restraint-caused injuries such as dislocated shoulders or a broken collar bone are reduced. As will be appreciated by those skilled in the art, the passenger restraint attachment 10 is suited for use by passengers having a medical impairment, such as sensitivity following a surgical procedure on the upper torso. Because the attachment 10 preferably conforms to the passenger's body and absorbs the shock applied to the passenger by the shoulder harness, it significantly reduces or eliminates discomfort felt by the passenger.

The passenger restraint attachment 10 can be configured to allow for display of indicia, logos, or printed messages. For example, in the illustrated embodiment, a window 40 is provided on a top surface 42 of the cushion 12, and other windows 44 are provided on side surfaces 46 of the cushion 12. These windows 40, 44 can be used to display any suitable message, logo, or image, thereby allowing for customization of the passenger restraint attachment 10. As will be apparent to those skilled in the art, the windows 40, 44 provide locations for advertising or for labeling.

In use, passenger restraint attachment 10 is attached to a shoulder harness S of a passenger restraint R by sliding the shoulder harness S into the shoulder harness receiver 18. The passenger positioned the attachment 10 over the shoulder to improve comfort and reduce clothes wrinkling. The lower surface 30 is positioned on the passenger's shoulder so the retainer 36 hooks over to the top of the shoulder, the concave portion 32 engages the shoulder, and the convex portion 34 extends downward from the shoulder along a front of an upper portion of the passenger's torso. The open cell foam portion 16 of the attachment 10 conforms to the shape of the passenger's body to provide a comfortable fit. Further the convex forward portion 34 of the attachment 10 lifts the shoulder harness away from the user's clothing, reducing the opportunity for wrinkling. If the passenger moves or leans in any direction, shoulder harness S freely slides within the shoulder harness receiver 18 to permit the movement, while retaining the attachment 10 and shoulder harness in an optimal position on the passenger. Because the passenger restraint attachment 10 reduces passenger discomfort, they are more likely to use passenger restraints, reducing potential injury or death.

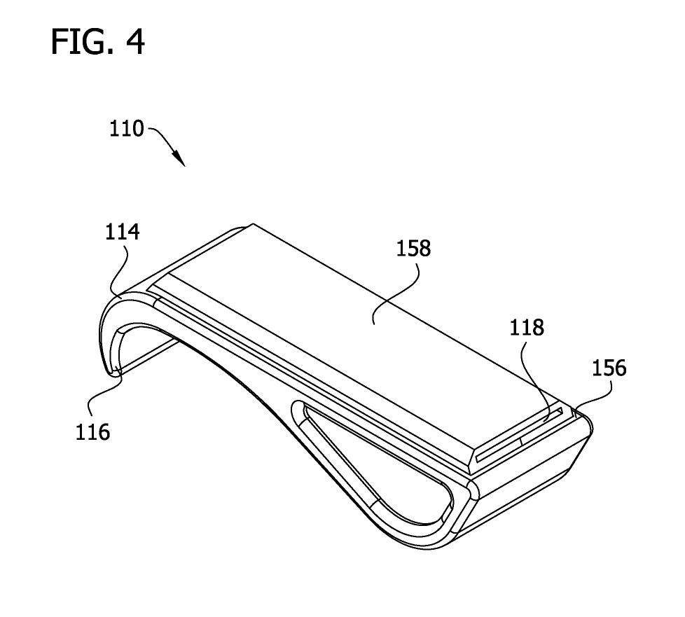

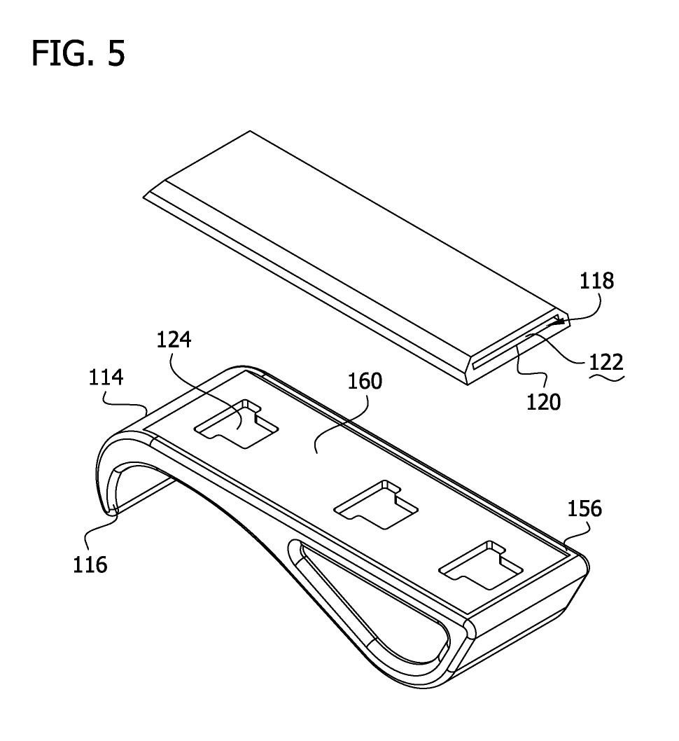

FIGS. 4 and 5 show a second embodiment of a passenger restraint attachment 110 according to the present invention. The attachment 110 of the second embodiment is similar to the attachment 10 of the first embodiment. Elements of the second embodiment that are similar to those of the first embodiment are numbered like those of the first embodiment but incremented by 100. The upper portion 114 of the attachment 110 includes a base 156 and a cover 158 formed as two separate pieces. The base 156 has a channel 160 adapted to receive the cover 158. The cover includes a shoulder harness receiver 118, which in the illustrated embodiment is a slot 120 having an opening 122 formed along a bottom surface of the cover. Once the shoulder harness S is in position in the slot 120 in the cover 158, the cover is secured to the base 156. In one embodiment, the cover 158 is secured to the base 156 by conventional mechanical fasteners 124 located on a bottom surface of the cover and a top surface of the base. In one embodiment the fasteners 124 are conventional fabric hook and loop fasteners. Other mechanical fasteners such as bayonet mounts are also envisioned as being within the scope of the present invention. Other than the two-piece configuration for receiving the shoulder harness S, the attachment 110 is substantially identical to attachment 10 described above. Accordingly, the attachment 110 of the second embodiment need not be described in further detail.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

What is claimed is:

1. A passenger restraint attachment for use by a passenger when wearing a passenger restraint having a shoulder harness for securing an upper torso of the passenger, the passenger restraint attachment comprising a cushion having an upper portion including a shoulder harness receiver and a lower portion having an S-shaped lower surface for engaging the body of the passenger.

2. A passenger restraint attachment of claim 1, wherein the shoulder harness receiver is configured to allow the shoulder harness to slide freely within the shoulder harness receiver.

3. A passenger restraint attachment as set forth in claim 2, wherein the lower surface maintains its position against the body of the passenger when the shoulder harness slides within the shoulder harness receiver.

4. A passenger restraint attachment as set forth in claim 1, wherein a curved portion of the lower surface is adapted to engage a shoulder of the passenger.

5. A passenger restraint attachment as set forth in claim 1, wherein the lower surface includes a retainer adapted to be positioned behind a shoulder of the passenger, thereby retaining the position of the passenger restraint attachment against the body of the passenger.

6. A passenger restraint attachment as set forth in claim 1, wherein the upper portion and the lower portion are formed separately.

7. A passenger restraint attachment as set forth in claim 6, wherein the lower portion is made of open cell foam.

8. A passenger restraint attachment as set forth in claim 7, wherein the upper portion is made of closed cell foam.

9. A passenger restraint attachment as set forth in claim 1, wherein the shoulder harness receiver comprises a slot for positioning the passenger restraint within the upper portion.

10. A passenger restraint attachment as set forth in claim 1, wherein at least one of the upper portion and the lower portion is adapted to display a logo.

11. A passenger restraint attachment for use by a passenger when wearing a passenger restraint having a shoulder harness for securing an upper torso of the passenger, the passenger restraint attachment comprising:
a closed cell foam portion for absorbing shock applied to the passenger by the shoulder harness due to changes in vehicle velocity, the closed cell foam portion including a slot adapted to receive the shoulder harness; and
an open cell foam portion mounted on the closed cell foam portion, the open cell foam portion conforming to a shape of a corresponding part of the passenger, the open cell foam portion being adapted to extend from a location on the upper torso behind a shoulder of the passenger to a location on the upper torso in front of the shoulder.

12. A passenger restraint attachment as set forth in claim 11, wherein opposing surfaces defining the slot include a fastener to secure the passenger restraint within the slot.

13. A passenger restraint attachment as set forth in claim 11, wherein the passenger restraint can freely slide within the slot without altering the position of the open cell foam portion against the body of the passenger.

14. A passenger restraint attachment as set forth in claim 11, wherein the open cell foam portion includes a generally S-shaped lower surface for engaging the passenger.

15. A passenger restraint attachment for use by a passenger when wearing a passenger restraint having a shoulder harness for securing an upper torso of the passenger, the passenger restraint attachment comprising a cushion having an upper portion including a shoulder harness receiver and a lower portion having a lower surface including a concave portion for engaging a shoulder of the passenger, the shoulder harness receiver in use engaging the shoulder harness and cantilevering the harness away from a forward edge of the concave portion by a distance that is greater than about 1.25 inches.

16. A passenger restraint attachment as set forth in claim 15, wherein the distance by which the shoulder harness receiver cantilevers the harness away from a forward edge of the concave portion is in a range from about 1.25 inches to about 2.0 inches.

17. A passenger restraint attachment as set forth in claim 16, wherein the distance by which the shoulder harness receiver cantilevers the harness away from a forward edge of the concave portion is in a range from about 1.5 inches to about 1.75 inches.
